(19) United States
(12) Patent Application Publication
(10) Pub. No.: US 2005/0087073 A1
(43) Pub. Date: Apr. 28, 2005

(54) Paint spray booth having scrubbing solution flow control

(76) Inventors: Adrien De Borchgrave d'Altena, Canton, MI (US); Gregory M. Still, Plymouth, MI (US); Raymond F. Lapierre III, Livonia, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/969,562

(22) Filed: Oct. 20, 2004

Related U.S. Application Data
(60) Provisional application No. 60/514,891, filed on Oct. 24, 2003.

(51) Int. Cl. B01D 47/00

(52) U.S. Cl. 96/245

(57) ABSTRACT

A paint spray booth having a scrubbing solution flow control, wherein the spray booth includes a floor having an opening, a scrubber beneath the floor, at least one elongated distribution trough having an overflow weir, a source of scrubbing solution and a pump pumping scrubbing solution from the source to the distribution trough. The flow control includes a control valve between the pump and the distribution trough, a level sensor monitoring a level of solution in the trough and a controller receiving a signal from the level sensor operating the control valve to maintain a predetermined level of scrubbing solution in the distribution trough.

### RELATED APPLICATIONS

This application claims priority to Provisional Application Ser. No. 60/514,891 filed Oct. 24, 2003.

### FIELD OF THE INVENTION

This invention relates to a paint spray booth having a scrubbing solution flow control. More specifically, this invention relates to a control for maintaining a predetermined level of scrubbing solution in the distribution trough of a paint spray booth and thus controls the volumetric flow of scrubbing solution received in the paint spray booth.

### BACKGROUND OF THE INVENTION

Paint spray booths for high volume applications, such as used by the automotive industry to spray paint automotive bodies and by other industries to spray paint large substrates, are continuously ventilated to remove paint overspray. The exhaust air from the paint spray booth carries the paint overspray, which are typically fine droplets of paint 1-10 micrometers, out of the paint spray booth. The overspray paint must then be removed from the exhaust air before it can be vented to atmosphere. The removal of the paint overspray is typically done by a wet scrubber system.

U.S. Pat. Nos. 5,100,442 and 6,228,154, both assigned to the assignee of this application, disclose wet scrubber systems. As will be understood by those skilled in this art, a wet scrubber system functions by contacting the exhaust air from the paint spray booth with a water based scrubbing solution, which is typically water with a surfactant to detacify the paint droplets, and other additives. The scrubbing system breaks the scrubbing solution into droplets (50 micrometers in diameter or larger) and contacts the fine paint particles entrained in air. The larger droplets of scrubbing solution are intermixed with air received from the paint spray booth having entrained smaller overspray paint droplets in turbulent flow through the scrubber, such that the small paint overspray droplets are adsorbed into the much larger scrubbing solution droplets. The scrubbing solution, now laden with paint overspray is then removed from the exhaust air from the paint spray booth by a separator and sent to a sludge tank for treatment. The exhaust air can then be vented to atmosphere or another destination.

A paint spray booth is typically an enclosed structure having a conveyor which transfers the articles to be painted through the paint spray booth and paint application equipment, such as rotary paint atomizers, are spaced along the length of the paint spray booth on one or both sides of the conveyor as required by the application. For example, a paint spray booth for automotive applications may be 18 feet wide and 200 to 300 feet long. The cross-section of a typical conventional paint spray booth is shown schematically in FIG. 1.

FIG. 1 illustrates a typical paint spray booth 20 for painting large articles, such as vehicle bodies 22 which are conventionally conveyed through the paint spray booth 20 on a conveyor 24. As will be understood by those skilled in this art, a conventional paint spray booth includes an air supply house 26 where ambient air is filtered and environmentally treated by dehumidifiers, humidifiers, heaters, coolers, etc. (not shown) prior to receipt in the painting area 32. The treated air is received from the air supply house 26 to the painting area 32 through a porous ceiling 28 as shown by arrows 30. Ventilation air is typically supplied to the painting area 32 from the air supply house 26 at a velocity in the range of 40 to 120 feet per minute. The downward flow of air in the painting area 32 is important as it prevents paint overspray from settling onto the previously painted areas of the article 22.

The enclosed painting area 32 includes a floor 34 having a slot or opening 36 in the floor and a scrubber or scrubbers 38 are supported in the floor 34 beneath the floor aligned with the opening 36 through the floor. As described in the above-referenced U.S. patents, the scrubber 38 may comprise an elongated scrubber or an aligned spaced series of scrubbers which receive air from the painting area 32 laden with droplets of paint overspray and scrubbing solution, wherein the larger droplets of scrubbing solution adsorb the smaller paint droplets or particles and separates the paint droplets from the incoming air. A pump 40 pumps clean scrubbing solution into troughs 42, typically located on the floor 34 of the painting area 32 on opposed sides of the painting area 32 through supply lines 44. The scrubbing solution 48 in the troughs 42 then flows over the overflow weirs 46 onto the floor 34 of the painting area 32 and into the scrubber or scrubbers 38 through opening 36 where the paint droplets are separated from the incoming air. The scrubbing solution with the separated paint droplets are then received in a tank 50 and conveyed through line 52 to a scrubbing solution tank 54. The cleaned air is then received through an exhaust 56 where it may be exhausted to atmosphere or another destination, as described above. The paint droplets are then removed either by a settling system or more typically a floating system, wherein the agglomerated paint droplets are skimmed from the scrubbing solution tank 54. A flocculant is typically added to the scrubbing solution in the scrubbing solution tank 54.

The efficiency of the scrubber 38 is strongly dependent upon the correct volumetric flow rate of the scrubbing solution 48 to the troughs 42. Either too much or too little scrubbing solution supplied to the troughs 42 by the pump 40 will be detrimental to the performance of the scrubber 38. At present, the volumetric flow rate of scrubbing solution supplied to the troughs 42 is determined by the initial setting of the pump 40. Because of the importance of the volumetric flow rate of the pump 40, the initial flow volume by the pump 40 into the troughs 42 is carefully measured and set up to the correct value when the paint spray booth 20 is first started up.

It is also important to distribute the flow volume properly over the length of the paint spray booth 20. Distribution is typically accomplished a pipe and manifold (not shown) extending the entire length of the paint spray booth 20 with supplied drops spaced approximately 10 feet apart. The piping system is designed such that the pressure drop through the drops is much greater than the pressure drop in the manifold so that a nearly equal volume of scrubber solution flows through each drop in the manifold. In addition, the scrubbing solution drops into a trough 42 on each side of the paint spray booth 20 which subsequently feeds water to the booth floor 34 over the continuous overflow weir 46, which in the disclosed embodiment, is an inner edge of the troughs 42. The edge of the weir 46 is thus carefully leveled to provide equal flow distribution over the entire length of the paint spray booth 20.

One problem encountered with state of the art paint spray booths is that over time, the volumetric flow rate of the scrubbing solution changes. This change is primarily caused by fouling of the supply piping and pumps. Both of these factors cause the volumetric flow rate of scrubbing solution 48 to the troughs 42 to decrease over time. This decrease will have a number of detrimental effects. First, the decreased water flow rate will reduce the air flow resistance of the scrubber 38. This will lead to an increase in exhaust air rate which causes a mismatch between the supply and exhaust airflow volumetric flow rates. This mismatch will result in air flowing parallel to the travel of the conveyor 24, which can cause paint overspray to drift into and settle onto undesirable areas resulting in quality problems with the article being painted. Second, if the flow rate drops sufficiently, the scrubbing efficiency of the scrubber 38 will be reduced to the point where plant environmental permit conditions may be violated. This can also have legal consequences, including fines and possible plant shut down. Thus, there has been a longstanding problem with the control of scrubbing solution to the troughs 42.

The scrubbing solution flow control of this invention solves this problem by a simple and efficient means and maintains a predetermined level of scrubbing solution in the distribution troughs 42.

### SUMMARY OF THE INVENTION

The paint spray booth of this invention may be generally conventional to permit retrofitting of existing paint spray booths with a scrubbing solution flow control. That is, the paint spray booth of this invention includes an enclosed paint spray booth receiving articles to be painted including a floor having an opening or a plurality of openings therethrough, a scrubber or scrubbers located beneath the floor opposite the opening or openings, an elongated distribution trough on at least one side of the floor having an overflow weir, a source of scrubbing solution and a pump pumping scrubbing solution from the source to the distribution trough, such that the scrubbing solution flows from the distribution trough over the overflow weir onto the floor and through the opening into the scrubber or scrubbers, removing paint droplets or particles from the air as described above.

The scrubbing solution flow control of this invention includes a control valve located between the pump and the distribution trough, a level sensor monitoring the level of the scrubbing solution in the distribution trough and a controller receiving a signal from the level sensor operating the control valve to maintain a predetermined level of scrubbing solution in the distribution trough or troughs. In one preferred embodiment, the level of scrubbing solution in the distribution trough or troughs is measured by a pressure transducer. However, other level sensors may also be utilized, including ultrasonic, capacitive, conductance, thermal, optical or mechanical level sensing devices. The level sensor then sends an electrical signal corresponding to the level of scrubbing solution in the trough or troughs to a controller. Again, the controller may be any conventional type of digital or analog system that produces an output signal capable of changing the position of a control valve to control the signal from the transducer to maintain a specific set value or “setpoint.” The control valve may also be any type of conventional valve capable of responding to the output from the controller and varying the scrubbing solution flow rate of the pump to the paint spray booth distribution trough. Alternatively, the controller can vary the scrubbing solution flow rate by controlling the speed of the pump through the use of an electronic or mechanical variable speed drive.

As will be understood, various modifications may be made to the paint spray booth having a scrubbing solution flow control of this invention within the purview of the appended claims and the disclosed embodiment of the scrubbing solution flow control of this invention in the following description of the preferred embodiments and drawings is for illustrative purposes only.

### BRIEF DESCRIPTION OF THE DRAWINGS

FIG. 1 is a schematic cross-sectional view of a conventional paint spray booth described above;

FIG. 2 is a schematic cross-sectional view of a paint spray booth having a scrubbing solution flow control of this invention; and

FIG. 3 is a graph of time versus level of scrubbing solution in the distribution troughs illustrating the efficiency of the scrubbing solution flow control of this invention.

### DESCRIPTION OF THE PREFERRED EMBODIMENTS

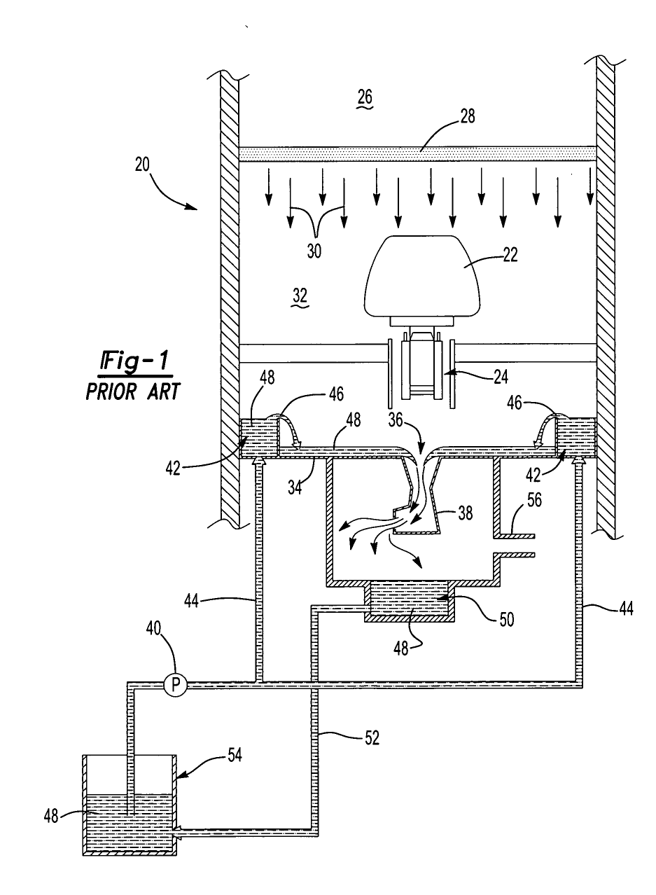

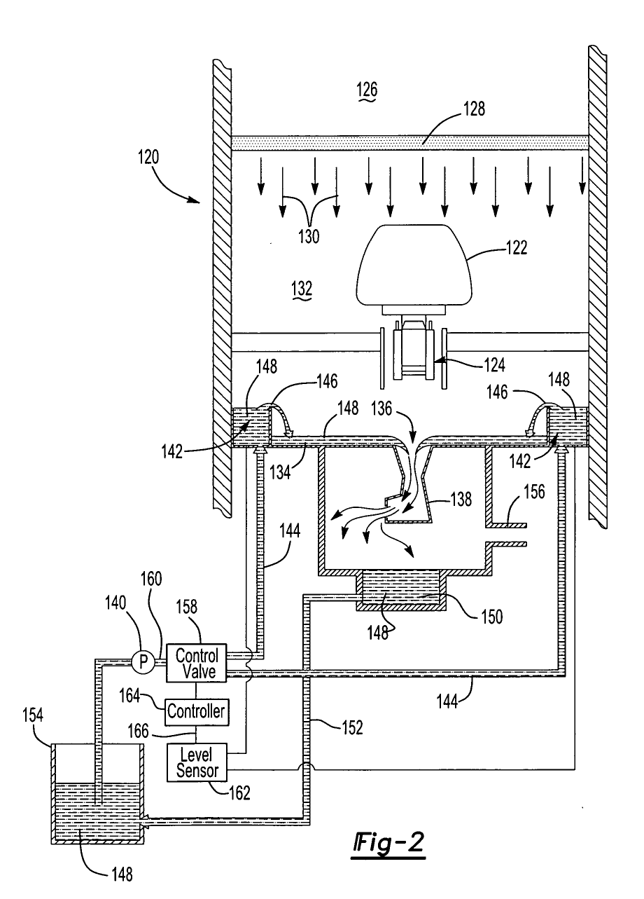

FIG. 2 illustrates a scrubbing solution flow control of this invention adapted for a conventional paint spray booth described above with reference to FIG. 1. That is, the paint spray booth 120 may be utilized to paint large articles, such as a vehicle body 122, which is conveyed through the paint spray booth on a conveyor 124. The paint spray booth 120 may include an air supply house 126 which conditions ambient air and the air is received under pressure through a porous ceiling 128 as shown by arrows 130 in the painting area 132. The painting area 132 includes a floor 134 having an opening or openings 136 and a scrubber or scrubbers 138 are located beneath the floor 134 aligned with the opening or openings 136. The painting area 32 further includes distribution troughs 142 preferably on opposed sides of the painting area 132 extending the length of the painting area, each having an overflow weir 146 and scrubbing solution 148 is supplied to the distribution troughs 142 by a pump or pumps 140 through supply lines 144. As described above, a tank 150 is located below the scrubber 138 which receives the scrubbing solution 148 with the adsorbed paint droplets and the scrubbing solution is then transferred through line 152 to the scrubbing solution tank 154. An exhaust 156 is also provided to exhaust the cleaned air to atmosphere or another destination. That is, the scrubbing solution flow control of this invention may be utilized with a conventional paint spray booth 120 described above or any conventional paint spray booth.

As now described, the scrubbing solution flow control of this invention controls the flow rate of scrubbing solution 148 to the distribution troughs 142 by measuring the level of scrubbing solution in the distribution troughs and controlling the flow rate of scrubbing solution from the pump 140 to the distribution troughs 142 to maintain a predetermined level of scrubbing solution in the distribution troughs. In the disclosed embodiment of the scrubbing solution flow control of this invention, a control valve 158 is located between the pump 140 and the distribution troughs 142 and the pump 140 pumps scrubbing solution through line 160 to the control valve 158. The level of scrubbing solution 148 in the distribution troughs 142 is measured by a level sensor 162 which sends an electronic signal corresponding to the level of scrubbing solution in the distribution troughs 142 to a controller 164 through line 166. The controller 164 then transmits a signal to the control valve 158 which adjusts the volumetric flow of scrubbing solution from the pump 140 to the distribution troughs 142. That is, the control valve 158 may be adjusted by the controller 158 to provide a predetermined flow rate to the distribution troughs 142 through line 144 or the control valve 158 may control the volumetric flow rate by controlling the speed of the pump 140 through the use of an electronic or mechanical variable speed drive. The scrubbing solution flow control of this invention thus controls the flow rate of scrubbing solution from the pump 140 to the distribution troughs 142 to maintain a predetermined level of scrubbing solution in the distribution troughs, thereby eliminating the problem associated with the prior art paint spray booth described above with reference to FIG. 1 and improving the efficiency of the scrubber 138 or scrubber system.

As described above, the control valve 158 can be any type of conventional valve capable of responding to the output signal from the controller 164 and varying the flow rate of the scrubbing solution to the paint spray booth distribution troughs 142. In a preferred embodiment, the control valve 158 is an electro-pneumatic valve which uses compressed air to open and close the valve with an electronic signal to control the compressed air, such as Model 4ACAADMFM2BC7 available from Tru-Tech Industries having a maximum pressure of 150 psi and a pipe diameter of four inches. However, as described above, the control valve 158 may be any type of control valve and a control valve to vary the speed of the pump 140 may also be utilized. A preferred embodiment of the level sensor 162 is a differential pressure transducer. The function of the pressure transducer is to measure the level of scrubbing solution 148 in the distribution troughs 142 and produce an electronic signal proportional to the level of scrubbing solution in the distribution troughs 142. A suitable differential pressure transducer is available from Dwyer Instruments, Inc., Model 655-1. The high pressure connection to the differential pressure transducer may be piped to the distribution troughs 142 through a pipe (not shown) preferably located below the normal level of scrubbing solution in the troughs and the low pressure connection of the differential pressure transducer is preferably unconnected outside the booth so that the level of scrubbing solution is referenced to ambient pressure. As set forth above, however, other suitable level sensors may also be utilized, including ultrasonic, capacitive, conductance, thermal, optical or mechanical level sensors. The controller 158 may also be any type of digital or analog system that produces an output signal from the level sensor 162 capable of changing the position of the control valve 158 to cause the signal from the level sensor 162 to maintain a predetermined specific set value or setpoint. A suitable programmable logic controller or PLC is available from Allen Bradley Company, wherein the programmable logic controller is programmed to monitor the electronic signal from the level sensor 162 and adjust the control valve 158 to maintain a set point.

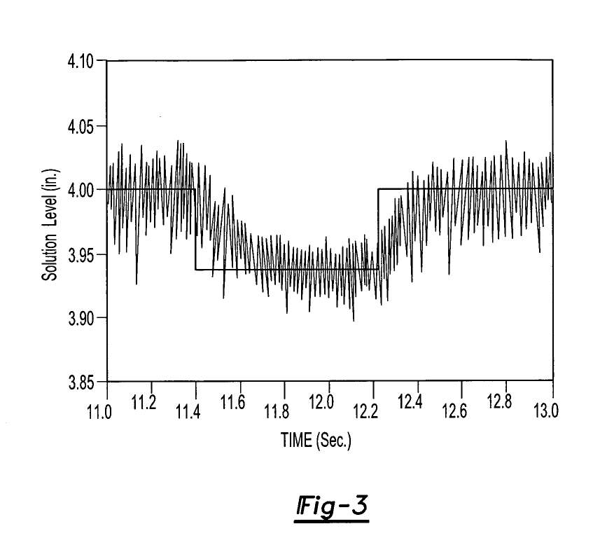

Testing of the scrubbing solution flow control of this invention was conducted by first adjusting the control setpoint to the normal flow rate of 32 gpm per foot of booth. After the system was running, a bypass valve was opened and closed, simulating changes in the piping flow resistance or pump performance. The bypass valve allowed water from the pump discharge to return to the tank without passing through the scrubber 138. The automated valve was able to adjust the flow through the spray booth to compensate for these changes. The programmable logic controller logging program was set up to run for a six hour period. During that time, the level setpoint was changed. FIG. 3 is a graphical illustration of the level of scrubbing solution in the distribution troughs 142 as read by a pressure transducer level sensor 162 and the setpoint plotted versus time. As can be observed from FIG. 3, the scrubbing solution flow control of this invention was able to respond to changes in set point in approximately three minutes. Further, it can be observed that the system was able to maintain the level of scrubbing solution in the distribution troughs 142 within ±0.05 w.c. of the setpoint. The scrubbing solution flow control of this invention thus maintain a predetermined level of scrubbing solution in the distribution troughs 142 and solve the problems associated with the prior art, including improved efficiency of the scrubber 138.

As will be understood by those skilled in this art, various modifications may be made to the paint spray booth and the scrubbing solution flow control of this invention within the purview of the appended claims. As set forth above, the scrubbing solution flow control of this invention may be utilized with any conventional paint spray booth and thus is not limited to a specific design of paint spray booths. Further, as set forth above, other types of level sensors may be utilized in the scrubbing solution flow control of this invention, although a differential pressure transducer is preferred. The control valve 158 may also be any type of conventional valve capable of responding to the output signal from the controller 158 or the controller may vary the scrubbing solution flow rate by controlling the speed of the pump 140 by electronic or mechanical means. Finally, any type of digital or analog controller may be utilized that produces an output signal capable of adjusting the control valve. Having described a preferred embodiment of the paint spray booth having a scrubbing solution flow control, the invention is now claimed as follows.

1. A paint spray booth having a scrubbing solution flow control, comprising:
an enclosed paint spray booth receiving articles to be painted including a floor having an opening therethrough, a scrubber beneath said floor opposite said opening, an elongated distribution trough on said floor having an overflow weir, a source of scrubbing solution, a pump pumping scrubbing solution from said source of scrubbing solution to said distribution trough, said scrubbing solution flowing from said distribution trough over said overflow weir onto said floor and through said opening into said scrubber removing paint droplets from air received in said scrubber from said paint spray booth; and
a scrubbing solution flow control, including a control valve between said pump and said distribution trough, a level sensor monitoring a level of said scrubbing solution in said distribution trough, and a controller receiving a signal from said level sensor and said controller operating said control valve to control the flow of scrubbing solution from said pump to said distribution trough to maintain a predetermined level of scrubbing solution in said distribution trough.

2. The paint spray booth as defined in claim 1, wherein said paint spray booth includes two distribution troughs on opposed sides of said paint spray booth and said scrubbing solution flow control includes a level sensor monitoring a level of scrubbing solution in each of said distribution troughs.

3. The paint spray booth as defined in claim 1, wherein said level sensor is a differential pressure transducer level sensor.

4. The paint spray booth as defined in claim 1, wherein said control valve is an electro-pneumatic valve.

5. The paint spray booth as defined in claim 1, wherein said controller varies the flow rate of scrubbing solution from said pump to said distribution trough.

6. The paint spray booth as defined in claim 1, wherein said controller varies the speed of said pump.
